(19) United States
(12) Patent Application Publication
(10) Pub. No.: US 2016/0161413 A1
(43) Pub. Date: Jun. 9, 2016

(54) SYSTEM AND METHOD FOR DETECTION OF CONTAMINANTS

(71) Applicant: Bubble Technology Industries Inc., Chalk River (CA)

(72) Inventors: Harry ING, Deep River (CA); Hugh Robert ANDREWS, Pembroke (CA); Michael DICK, Mcleold Hill (CA); Tobias ACHTZEHN, Deep River (CA); Vernon Theodore KOSLOWSKY, Deep River (CA)

(21) Appl. No.: 14/953,263

(22) Filed: Nov. 27, 2015

Related U.S. Application Data
(60) Provisional application No. 62/087,029, filed on Dec. 3, 2014.

(51) Int. Cl. G01N 21/65; G01N 21/94

(52) U.S. Cl. CPC G01N 21/658; G01N 21/94; G01N 2201/068

(57) ABSTRACT

Described is a system and method for detecting contaminants using a flexible Surface Enhanced Raman Spectroscopy (SERS) substrate. The contaminant is collected on a flexible SERS substrate and directly interrogated with a Raman Spectrometer to obtaining a SERS emission spectrum for the contaminant. The obtained spectrum can be compared to a library of SERS signatures to identify the contaminant.

### CROSS-REFERENCE TO RELATED APPLICATION

This application claims the benefit of U.S. Provisional Application No. 62/087,029 filed Dec. 3, 2014.

### FIELD OF THE INVENTION

The present invention pertains to a system and method for detection of contaminants. More specifically, the present invention pertains to the detection of contaminants using flexible Surface-Enhanced Raman Scattering (SERS) substrates and Raman spectroscopy.

### BACKGROUND

Surface-Enhanced Raman Spectroscopy (SERS) is a surface-sensitive technique that enhances Raman scattering by molecules adsorbed onto a surface. Strong enhancement (>10⁶) of the Raman scattering signal can be obtained allowing high trace detection efficiency. Such signal amplification offered by SERS has driven various groups to investigate numerous techniques to develop reliable substrates and methods for the practical application of SERS (Tian, Z. Q., Internet Journal of Vibrational Spectroscopy, 4, Ed. 2 section 1). Over the last few years, metallic substrates have become commercially available and the use of SERS has begun to become an increasingly acceptable laboratory analytical tool.

In using SERS substrates that are metallic and rigid, the sample to be detected is prepared in a liquid phase which is applied onto the SERS substrate which is coated with plasmonic nanoparticles. Typically, the sample is allowed to dry to achieve intimate binding of the analyte to the nanoparticles before it is analyzed using SERS instrumentation. Metallic rigid SERS substrates can be extremely expensive because of the complex chemical microfabrication or nanofabrication production process required for their manufacture.

International PCT patent application No. WO 2011029888A1 describes a method and device for detecting a drug substance from exhaled breath of a subject in situ. United States Patent application publication No. 2012/0133932 describes a combination of SERS and stroboscopic signal amplification for the detection of trace contaminants in different environments using a SERS substrate which is a textured metal surface.

U.S. Pat. No. 7,989,211 describes a SERS method for detection and identification of perchlorate (ClO₄⁻), technetium (TcO₄⁻), uranium and nitrate in environmental samples. The SERS substrate comprising a metal nanoparticle in the form of colloidal gold modified with an organic molecule is mixed with the environmental sample and applied to a glass slide to obtain the Raman spectrum of the sample.

In other examples, the SERS substrate is made by ejecting plasmonic particles on a quartz substrate (Fierro-Mercado, P. et al., Chem. Phys. Letters 552 (2012) 108-113) or by absorbing of plasmonic particles on a silicon or fibrous mat substrate (C. H. Lee et al., Nanotechnology 12 (2011) 257311). The analyte is dissolved in a solvent and a small aliquot of the solution is applied to the SERS substrate and allowed to dry, then the sample is interrogated using Raman spectroscopy.

The use of the liquid phase in the preparation of the SERS sample and the transferring of the analyte in solution to the SERS substrate by pipetting or the mixing of the analyte with the plasmonic particles in a liquid phase and then depositing an aliquot on a glass slide are not suitable for most in-field applications. These are conventional analytical techniques utilized in chemical laboratories.

More recently, inexpensive, flexible SERS substrates have been produced (Lee, C. H. et al., Anal. Chem. 83 (2011) 8953-8958; Fierro-Mercado, P. M. et al., Inter. Jour. Spectroscopy 2012 (2012) 716527; Yu, W. W. et al., Anal Chem. 82 (23)(2010) 9226-9630) using plasmonic particles in an ink that can be printed on a paper substrate using an ink-jet printer.

United States Patent Application publication No. 2013/0107254A1 describes SERS analytical devices and methods of detecting a target analyte by using an ink-jet printer to print microdots onto a flexible substrate. Flexible SERS substrates are described for swabbing a surface, and the swabs are placed into a solvent to carry analyte molecules from the sample to the sensing region prior to Raman interrogation.

Operation, decontamination and decommissioning (D&D) of nuclear facilities is a very difficult and expensive endeavour. Regulations require that all materials must be subject to monitoring before leaving the site, and that workers be subject to routine exposure screening. The requirement for monitoring adds a significant financial burden to the day-to-day operation as well as the decontamination and decommissioning of such nuclear facilities.

Apart from the heavy labour cost involved in the monitoring process itself, there are many technological challenges to performing the mandated monitoring required to meet the maximum permissible levels specified by various regulations. For the decommissioning of nuclear facilities, the report by the European Commission (Burgess, P. H., “Handbook on Measurement Methods and Strategy at Very Low Levels and Activities”, European Commission Nuclear Safety and the Environment Report, EUR 17624, (1998)) describes in some detail various specialized techniques for the detection of various radioactive contaminants that are applicable for the radiation levels specified by regulations.

Radionuclides that emit alpha particles and/or low energy beta particles can pose a particular challenge since they are difficult to detect with current portable radiation instrumentation. The detailed analysis by the European Commission concluded that four nuclides in particular (³H, ⁶³Ni, ¹⁵¹Sm and ²⁴¹Pu) cannot be measured with portable instrumentation. The report highlights the operational difficulties and limitations of α-monitoring and β-monitoring techniques in relation to existing instrumentation for such applications.

The detection of uranium and transuranic elements poses special challenges to the detection of contaminants at regulatory levels since these radionuclides are predominantly α-emitters. Since α-particles only travel a few centimetres in air, the radiation detector is generally within ≦10 mm of the contamination. Also, these isotopes have low specific activity due to their long half-lives. For instance, the control limits for uranium (3 μg per gram of kidney tissue) is established by chemical toxicity of uranium, as opposed to its radiological hazard. For surface contamination, this translates into 1000 dpm/100 cm² for removable contamination and 5000 dpm/100 cm² for fixed contamination (10 CFR Appendix D to Part 835—Surface Contamination Values, United States Department of Energy). These species are therefore difficult to detect with existing instrumentation in practice (Nuclear Weapons Accident Response Procedures (NARP), 3150.08M, Office of the Assistant Secretary of Defence, United States Department of Defence). For airborne contamination, this level of activity equates to 0.05 mg/m³ for soluble compounds and 0.25 mg/m³ for insoluble compounds (U.S. Occupational Safety and Health Standards 29 CFR 1910.1000).

Tritium is another contaminant that is difficult to monitor or detect using conventional portable instrumentation because of its extremely low-energy beta emission (Emax=18.6 KeV). Tritium also has a very strong tendency to become absorbed into surfaces, even into metals such as stainless steel, which makes surface monitoring unreliable. A common method for tritium detection is to take a swipe and count the radiation on the swipe using a liquid scintillation counter, or by using a windowless counter. Due to interference from ambient radiation background, windowless counters are very difficult to use for measurement of low-levels of tritium contamination. Current methods of detection of radionuclides limit the use of such instruments in practice to clean, flat, metallic surfaces, such as inside glove boxes. The measurement of radionuclides that are difficult to detect in-field and other hazardous (non-radioactive) chemicals presently requires sample analysis done by off-site laboratory facilities.

There are other common contaminants in nuclear facilities that are non-radioactive, but are chemically hazardous and also require monitoring. They include but are not limited to Pb, Hg, Cd, Be, Na, cyanide, asbestos and polychlorinated biphenyls. Some of these species are found in materials such as paints, oils and plasticizer for organic polymers. (IAEA, Technical Report 441, Management of Problematic Waste and Material Generated During the Decommissioning of Nuclear Facilities). Similar to radiological hazards, regulations for Threshold Limit Values are specified for such chemical species. Of course, these chemical species are also found in non-nuclear industrial operations and non-nuclear facilities. Decommissioning of mine dumps have encountered additional contaminants such as Mo, Cu, As, and Fe (Decommissioning Projects—South Africa, http://www.wise-uranium.org/udza.html, Nov. 16, 2014). Thus, both organic and inorganic contaminants may be of concern in industrial operations.

Piltch et al. describe trace detection of uranium compounds by SERS using slurries of oxides mixed with colloidal gold particles or on the surface of high conductivity gold plated substrates (Piltch et al., Surface Enhance Raman Scattering Investigation of Uranium Hydride and Uranium Oxide, MST-6, ADC, 7-10-07). Eshkeiti et al. have published SERS spectra for ZnO, HgS, and CdS using a SERS substrate comprised of silver nanoparticle printed onto a silicon wafer (Eshkeiti et al., Proc. Eurosensor XXV, Sep. 4-7, 2011, Athens, Greece, Procedia Engineering 25 (2011) 338-341). Han et al. have measured SERS spectra for trace amounts of arsenic in the common form of As(V) (Han, M-J. et al., Analytica Chimica Act, 692 (2011) 96-102) using SERS substrates consisting of multilayers of Ag nanofilms deposited on glass slides using an electroless deposition process. The arsenic was deposited on the SERS substrates in the form of liquid electrolytes using a pipette. It is notable that inorganic molecules have relatively small Raman scattering cross-sections.

There remains a need for new techniques and instruments for the detection of contaminants under field conditions.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

Described herein is a system and method for detection of contaminants using SERS Raman spectroscopy.

An aspect of the present invention is to provide a method of detecting a contaminant on a surface comprising: swiping the surface with a flexible SERS substrate; and directly interrogating the flexible SERS substrate with a Raman Spectrometer to obtain a SERS emission spectrum of the contaminant.

In one embodiment, the flexible SERS substrate is dry. In another embodiment, the flexible SERS substrate is moistened to aid in transferring the contaminant from the surface to the flexible SERS substrate.

In another embodiment, the surface is a non-SERS swipe. In another embodiment, the method further comprises identifying the contaminant by comparing the SERS emission spectrum of the contaminant to a library of SERS emission spectra.

In another embodiment, the method further comprises quantifying the contaminant on the surface. In another embodiment, the contaminant is an industrial contaminant, a nuclear contaminant, or both. In another embodiment, the method further comprises detecting more than one contaminant.

Another aspect is to provide a system for detecting a contaminant on a surface, the system comprising: a Raman Spectrometer for receiving a flexible SERS substrate which has been swiped on the surface; and a memory comprising a library of SERS emission spectra for a plurality of contaminants.

In an embodiment, the system further comprises a radiation detector. In another embodiment, the radiation detector is capable of detecting alpha particles, beta particles, or both. In another embodiment, the library of SERS emission spectra comprises SERS spectra for nuclear contaminants.

Another aspect is to provide a method for detecting a contaminant on a surface, the method comprising: applying a mixture containing plasmonic nanoparticles to the surface; interrogating the surface with a Raman Spectrometer; and obtaining a SERS emission spectrum for the contaminant.

In an embodiment, the method further comprises identifying the contaminant by comparing the SERS emission spectrum of the contaminant to a library of SERS emission spectra. In another embodiment, the contaminant is an industrial contaminant, a nuclear contaminant, or both.

In another embodiment, the mixture comprises a colloid containing plasmonic nanoparticles dispersed in a carrier solvent at a suitable viscosity, spiked by reagents that: assist in the bonding of the nanoparticles to the selected industrial contaminant; and/or chemically react with the contaminant so as to achieve a high surface enhancement factor for Raman Spectroscopy.

In another embodiment, the step of applying the colloid comprises spraying, squirting, dripping, painting or a combination thereof. In another embodiment, the surface is in a nuclear facility or an industrial facility.

Another aspect is to provide a system for detecting contaminants in air, the system comprising: a flexible SERS substrate; means for mounting the flexible SERS substrate such that it is exposed to air; and a Raman spectrometer for interrogating the flexible SERS substrate to obtain a SERS emission spectrum for the contaminant.

In an embodiment, the system comprises a plurality of flexible SERS substrates. In another embodiment, the plurality of flexible SERS substrates are in a cartridge or in a continuous strip.

In another embodiment, the system further comprises a memory comprising a library of SERS emission spectra for a plurality of contaminants, wherein the system is capable of comparing the spectral emission of the contaminant to the library of SERS emission spectra to identify the contaminant.

Another aspect is to provide a method for detecting a contaminant in air, the method comprising: sampling air by exposing a SERS substrate to air; interrogating the SERS substrate with a Raman spectrometer to obtain a SERS emission spectrum for the contaminant; and identifying the contaminant by comparing the SERS emission spectrum for the contaminant to a library of SERS emission spectra.

In an embodiment, the sampling of air is continuous. In another embodiment, the contaminant in air is a nuclear contaminant, an industrial contaminant, or both. In another embodiment, the SERS substrate is a flexible SERS substrate.

Another aspect is to provide an apparatus for detecting an industrial contaminant, the apparatus comprising: a Raman Spectrometer for receiving a flexible SERS substrate having the industrial contaminant thereon and adapted to provide a SERS emission spectrum of the industrial contaminant; and a radiation detector adapted to detect radiation from the industrial contaminant on the flexible SERS substrate.

In an embodiment, the apparatus further comprises a memory comprising a library of SERS emission spectra for a plurality of industrial contaminants. In another embodiment, the flexible SERS substrate is dry. In another embodiment, the radiation detector is capable of detecting alpha particles, beta particles, or both. In another embodiment, the library of SERS emission spectra comprises SERS spectra for nuclear contaminants.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 is a photograph of an exemplary SERS substrate for detection of contaminants

FIG. 2 shows three gamma-ray spectra, taken with a NaI gamma-ray spectrometer, taken of dried trans-1,2-bis(4-pyridyl)ethylene (BPE) on two different substrates. The BPE was spiked with ¹³⁷Cs to serve as a radioactive tracer for determination of wiping efficiency;

FIG. 3 shows two SERS spectra of BPE spiked with ¹³⁷Cs;

FIG. 4 shows two background-subtracted SERS spectra for lead, obtained using dry SERS swipes;

FIG. 5 shows three background-subtracted SERS spectra for Uranium, obtained using dry SERS swipes;

FIG. 6 shows a background-subtracted SERS spectrum for Cadmium, obtained using a dry SERS swipe;

FIG. 7 shows a background-subtracted SERS spectrum for an arsenic compound, obtained using a dry SERS swipe;

FIG. 8 shows background-subtracted SERS spectra from a wet and a dried deposit of tritiated paint on a flexible SERS substrate;

FIG. 9 shows a background-subtracted SERS spectrum from a dry swipe of dried tritiated paint;

FIG. 10 is an exemplary device for detecting of nuclear and/or industrial contaminants;

FIG. 11 shows SERS spectra of a dry swipe of a dried deposit of BPE and a dry swipe of that swipe;

FIG. 12 is SERS spectrum of a dry swipe of 3 μg of cocaine;

FIG. 13 is SERS spectrum of a dry swipe of 3 μg of heroin;

FIG. 14 is SERS spectrum of a dry swipe of 3 μg of TNT;

FIG. 15 shows three spectra of SERS swipes of a BPE deposit, substrates were moistened with water, methanol and toluene before the swipe and spectra were recorded after swipes were dried;

FIG. 16 is a SERS spectrum from a sample prepared by depositing 54 pg BPE on flexible SERS substrate and then dried;

FIG. 17 is a background-subtracted SERS spectrum of gasoline from a substrate used as a filter in an air sampling system; and

FIG. 18 shows two background-subtracted SERS spectra of BPE, the dotted line represents BPE deposited on top of the SERS substrate, while the solid line is for a SERS substrate material deposited on top of a dry BPE deposit.

### DETAILED DESCRIPTION OF THE INVENTION

Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or elements(s) as appropriate.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The term “suitable” as used herein means that the selection of the particular compound or conditions would depend on the specific manipulation to be performed, and the identity of the molecule(s) to be detected, but the selection would be well within the skill of a person trained in the art. All process/method steps described herein are to be conducted under conditions sufficient to provide the results shown. A person skilled in the art would understand that all conditions can be varied to optimize the desired results and it is within their skill to do so.

As used herein, the term “flexible SERS substrate” refers to a material comprising a flexible structure to which a plurality of plasmonic nanoparticles has been embedded therein or thereon for forming a SERS sensing region. The “substrate” is the flexible material or media to which the plasmonic nanoparticles are applied. The “SERS sensing region” is the region on the substrate onto or into which the plasmonic nanoparticles are applied. Non-limiting examples of substrates which can support the plasmonic nanoparticles are cellulose, modified cellulose, glass fibres, nylon, kapton, polyvinylidene fluoride, natural polymers, synthetic polymers, metal, and combinations thereof. The plasmonic nanoparticles can comprise, but are not limited to, silver, gold, copper, iron, cobalt, nickel, rhodium, palladium, titanium oxide, zinc, and platinum, and combinations thereof.

As used herein, the term “contaminant” refers to any species that is desired to be detected. Such contaminants can be found in very small quantities on surfaces or in air. Contaminants to be detected can be organic, inorganic, nuclear, or a combination thereof.

As used herein, the term “industrial contaminant” refers to any contaminant of interest for detection in an industrial setting. The industrial contaminant can be present, for example, at a nuclear facility, in the mining industry, or at other industrial sites. These species can be, for example, radionuclides, metals, heavy metals, radioactive elements, radioactive compounds, inorganic and organic compounds, or other contaminants of concern. Non-limiting examples of industrial contaminants are deuterium, tritium, uranium, thorium, cadmium, lead, arsenic, molybdenum, iron, copper, sodium, cyanide, asbestos and polychlorinated biphenyls. As used herein, the term “industrial contaminant” can also refer to explosives, such as trinitrotoluene (TNT), commonly used in the mining industry, and to drugs, such as cocaine and heroin, commonly tested for workers as part of human resources mandate, or in public or private drug search operations. Other industrial contaminants can include, but are not limited to, agricultural contaminants such as pesticides, insecticides, herbicides, food contaminants such as food additives, toxins, packaging residues and chemical residues, and environmental contaminants.

As used herein, the term “radionuclide” refers to an atom, or species containing an atom, with an unstable nucleus capable of undergoing radioactive decay resulting in the emission of gamma rays, alpha particles and/or beta particles. Radionuclides can occur naturally, or can be produced artificially such as in a nuclear reactor. As used herein, the term “radionuclide” also refers to chemical compounds comprising one or more radioactive species.

As used herein, the term “nuclear contaminant” refers to an industrial contaminant which is or comprises a radionuclide.

As used herein, the terms “SERS emission spectrum” and “spectral signature” and “signature” describe the emission spectrum obtained for a particular contaminant, element, isotope, or chemical species using Raman spectroscopy. In the present case, the Raman spectroscopy is SERS Raman spectroscopy.

As used herein, the term “plasmonic nanoparticle” pertains to the component of the SERS substrate which amplifies the Raman scattering signature.

Herein is provided a system and method for detection of contaminants. Also described herein is a system and method for the detection of contaminants using flexible SERS substrates and Raman spectroscopy.

Also described herein is a method and system for the detection of trace amounts of nuclear contaminants, industrial contaminants and other toxic or hazardous contaminants using SERS Raman technology.

Also described herein is a method for the application of SERS technology to the detection of toxic or hazardous contaminants on site by the use of SERS and portable Raman detection equipment.

Also described herein is a system and method for the detection of nuclear contaminants for monitoring, decontamination or decommissioning of industrial operations, with particular application in nuclear facilities. The system and method for detection of nuclear contaminants is capable of being used at the nuclear site for the rapid detection of nuclear contaminants. A broad range of industrial contaminants can be found at nuclear and industrial facilities. The properties of these industrial contaminants vary and includes radionuclides having different half-lives, detectability and toxicity as well as chemically hazardous contaminants. Because of these varied properties, detection of a broad range of each of the industrial contaminants at once can be difficult. The present method and system can be used to detect a broad variety of industrial contaminants at the same time.

The present method and system has application in contamination control in operational facilities for the protection of workers, and in the decontamination and decommissioning of such facilities at the end of their useful lives. The present method and system can also be used in demolition work or for the classification of removable materials in relation to options for their disposal.

The presently described SERS technology can be used in a field setting to determine whether the level of a particular contaminant is below or above a maximum value established by regulatory agencies. In this way, a rapid indication of the presence of a particular contaminant can be determined in order to limit the number of samples that need to be sent away for off-site laboratory analysis and to allow timely decisions to be made without the necessity of waiting for results from off-site lab-analysis to be available. Results can thus be obtained in a timely, cost-effective manner.

In one embodiment, the present SERS substrates can be swiped onto a surface of interest, and then interrogated on site using a portable Raman spectrometer. The use of a liquid medium to prepare SERS samples is not convenient for most field applications. From an operational perspective, it is most desirable to be able to simply swipe a suspect contaminated surface with a dry flexible substrate.

The present method can employ the use of a dry swipe to collect a contaminant from a surface. Liquid deposition onto a SERS substrate is common, however it has been found that SERS samples can be prepared by simple dry swiping as opposed to liquid deposition. Previous thought was that the use of a solvent on the SERS substrate to dissolve the analyte or compound to be tested in solution followed by drying permits more intimate contact between the analyte and the nanoparticle microstructures, enabling stronger coupling between the laser light and plasma vibrations to produce stronger SERS signals. In this way, it has been understood to date that a solvent is required for intimate contact between the analyte to be probed and the plasmonic nanoparticles of the SERS substrate in order to obtain sufficient spectral signal. Accordingly, a “dry process” for sample preparation has thus far been understood to not allow sufficiently intimate contact with the SERS substrate. This is demonstrated herein not to be the case.

It is demonstrated herein that swiping a surface with a flexible SERS substrate is effective to obtain sufficient spectra signal. Accordingly, the present method can be done using a dry flexible SERS substrate, or the swipe can be moistened prior to swiping. For surfaces with very low levels of industrial contaminants, moistening the SERS swipe can increase the detection efficiency. The use of a flexible SERS substrate in a dampened or wet state using an appropriate solvent (such as, but not limited to water, alcohol, toluene or mild acid) can be used for sampling industrial contaminants or substances of interest on a surface to increase the swiping efficiency, improve physical pick-up and/or improve surface contact. It has also been found that swiping a dry flexible SERS substrate onto a surface or material of interest can pick up sufficient material onto the SERS substrate to enable detection of a compound of interest at the site of the contamination. In this way, a flexible SERS substrate can be used in a “dry process” for sample preparation and still allow sufficient intimate contact to allow the SERS substrate nanoparticle microstructures to produce a sufficient SERS signal. Prior art methods teach the dipping of a swiped SERS substrate into a solvent to encourage intimate contact of the surface contaminant with the nanoparticles on the SERS sensing region, however this is herein demonstrated not to be required for obtaining sufficient signal for contaminant detection.

The detection of inorganic compounds has also been demonstrated. Organic molecules, such as drugs and explosives, are large molecules having large scattering cross-sections that are relatively easy to detect using SERS Raman spectroscopy. Thus, it is not surprising that the bulk of SERS-related research to-date has dealt with organic compounds. In contrast, there has been little work done on inorganic molecules having small scattering cross-sections using SERS.

After swiping, Raman spectroscopy of the sample collected on the flexible SERS substrate can then be interrogated by a Raman spectrometer to identify the contaminant. Preferably, the Raman spectrometer is a portable device, and the flexible SERS substrates can be interrogated at the site where the swiped sample is obtained. In another embodiment, flexible SERS substrates can be interrogated not at the site where the swipe was taken, but at a remote site, such as in a laboratory setting. Both wet and dry swiped samples can be effectively interrogated by a Raman spectrometer.

Flexible SERS substrates can be prepared by combining silver or gold nanoparticles with binders and solvents to produce an ink suitable for deployment in an ordinary ink-jet printer cartridge. Flexible SERS substrates can be made on different substrate media, such as, for example cellulose ester membrane, glass-fibre, and cellulose fibre. Other non-limiting examples of substrate media such as nylon, polyvinylidene fluoride (PVDF), cellulose, modified cellulose, kapton, natural polymer, synthetic polymer, glass fibres, a metal, or combinations thereof can also be used as support media for a SERS surface.

SERS ink formulations can also be prepared, and patterns of nanoparticles microstructure can be printed on various substrates to obtain the flexible SERS substrate.

Any suitable flexible SERS substrate can be used in the present invention. Flexible SERS substrates can be used in a rugged or industrial environment, such as may be encountered in a decontamination or decommissioning environment, or in an emergency clean up after an accident.

The present system and method for in-field trace detection for detection of contaminants can, of course, also be applicable to larger organic molecules and biologicals, providing in-field SERS detection capabilities for a variety of other applications, such as trace explosive and other organic detection, contraband detection and monitoring for pesticides and bacterial contamination of foodstuff as well as other containments in our everyday environment.

The flexible SERS substrates may be packaged inside sealed pouches to maintain good performance against adverse environmental conditions or prolonged storage. In one embodiment, the sealed package could contain a sufficient quantity of fluid (e.g. water, toluene, mild acid, alcohol), optionally spiked with an appropriate reagent to maintain the SERS substrate in a moist environment. The packaging could increase the use-life of the SERS substrate, allowing the flexible SERS substrates to be stored until needed. Furthermore, the moistened substrate, especially if it is spiked with an appropriate solvent that assists in removing the contaminant from the surface to be swiped, could improve the swiping efficiency by picking up more loose contamination (e.g. a degreaser for oily surfaces).

Special reagents can also be added that could improve the surface-enhancement factor for Raman scattering. For example, the use of benzenethiol (BT) has been found (Biggs, K. B. et al., J. Phys. Chem A (2009) 4581-4586) to increase the detection efficiency for chemical warfare agents by Ag SERS substrates by about three orders of magnitude. A tracer such as Rhodamine 6G (R6G), BPE, citrate, azobenzene, pyridene or cyanine dyes can also be added to the fluid to provide a rough indication of contamination level. For example, one picogram of BPE added to the solution can provide a reference response to track potential changes to the SERS efficiency of the substrate with time. For a more quantitative assessment of analyte concentration, a known amount of the contaminant or a suitable tracer can be dispersed on a similar surface and a separate measurement made with a swipe to provide the needed calibration factor.

### EXAMPLES

To gain a better understanding of the invention described herein, the following examples are set forth. It should be understood that these examples are for illustrative purposes only. Therefore, they should not limit the scope of this invention in any way.

An Ocean Optics laser system with a wavelength of 785 nm was used to obtain the Raman spectra. The multimode diode laser can provide laser output of up to 300 mW. To avoid damage on the samples, a laser power of 11 mW was used for all of the measurements. An RPB Laboratory Probe from InPhotonics™ was used to transport and focus the laser light onto the SERS samples. This probe includes two optical fibres, one fibre for the laser light and the second fibre to transport the scattered light to the spectrometer. A probe internal optical system produced a focal length of about 7 mm to 8 mm. The same optical system collected the scattered light and suppressed the laser line before the light went into the spectrometer.

The analysis of the scattered light was performed with an Ocean Optics Spectrometer, type QE PRO. This spectrometer was equipped with grating #6 from Ocean Optics, which has 1200 lines per millimetre and Blaze angle optimized for a wavelength of 750 nm. The grating efficiency for the region of interest (800 nm to 930 nm) averaged to about 55%. An electronically cooled CCD chip was used to record the spectra of the scattered light. This spectrometer provides a spectral range for Raman and SERS measurements from about 300 cm⁻¹ up to about 2000 cm⁻¹. Ocean Optics also provides the required control and data acquisition software for this turnkey system. Version 1.3.4 of the Ocean View software was used to perform the described experiments.

SERS substrates were prepared on printer paper and on Whatman™ filter paper using the printer method and have demonstrated enhancement of the Raman signal similar to those reported by other groups. Prior groups have reported on the preparation of SERS substrates on filter paper. Lee, C. H. et al. (Anal. Chem. 83 (2011) 8953-8958) prepared the SERS substrates using the film-overnanostructure (FON) approach. In this approach a solution of gold bipyramid (Mettela, G. et al., Nature Scientific Report 3 (2013) Article number 1793) is absorbed on filter paper which after drying forms a uniform decoration of gold nanorods approximately 60 nm long and 18 nm in diameter, which is tightly bonded to the paper due to electrostatic interaction. This method involving the deposition of gold bipyramid solution on the filter paper can also be carried out using an ink-jet printer.

Two other groups used colloids to produce the SERS nanoparticles, which is a more common approach due to ease of preparation. Fierro-Mercado, P. et al. (Chemical Physics Letters 552 (2012) 108-113) followed the recipe of Silvert et al. (Mater. Chem. (2012) 108-113). In essence, this method utilizes the reduction of silver nitrate in ethylene glycol in the presence of polyvinylpyrrolidone (PVP) at elevated (120°) temperature. The separation of silver nanoparticles from the ethylene glycol was done by adding large amounts of acetone to the cooled solution followed by centrifugation. The precipitate was then mixed with solvent to attain a viscosity suitable for deployment as ink in a ink-jet printer (HP51645A). Yu, W. W. et al. (Anal Chem 82 (2010) 9626-9630) prepared their nanoparticles following the classic recipe of Lee et al. (Lee, P. C. et al., Phys. Chem. 86 (1982) 3391-3395). This method involved the reduction of AgNO₃ by sodium citrate in elevated temperature (100°), followed by centrifugation after cooling. The supernatant was removed and glycerol was added to the remaining solution to adjust the viscosity for use as ink.

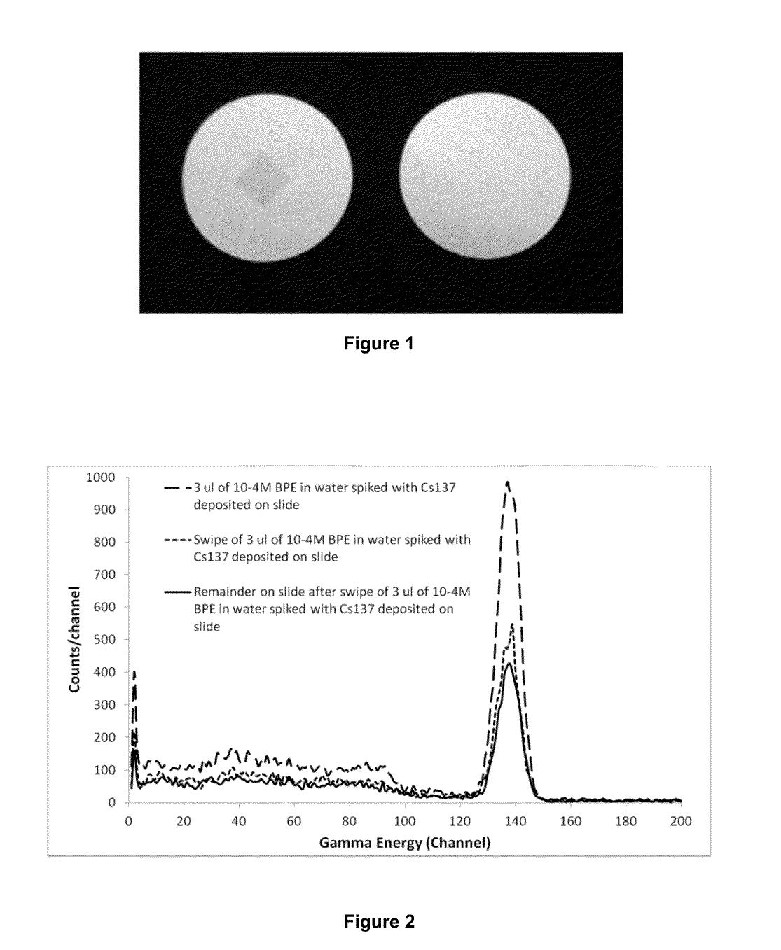

The recipe used herein was similar to the recipe reported by Yu et al. (Yu, W. W. et al., Anal Chem 82 (2010) 9626-9630). In essence, 90 mg of silver nitrate was added to 500 ml of water, the solution was brought to a boil, whereupon was added 100 mg of sodium citrate. The mixture was boiled for another 20 minutes, then the solution was cooled, and centrifuged at 3000 g for 6 hours to concentrate nanoparticles by 100×. A separate 10 mg/ml dextran solution in water was prepared and then the concentrated nanoparticle solution and dextran solution were mixed in a 1:1 ratio. The mixture was then printed on Fisher™ chromatography paper or Whatman™ filter paper using an Epson Workforce™ 30 ink-jet printer. FIG. 1 shows a photograph of a SERS substrate used for detection of industrial contaminants made following this recipe for the preparation of SERS substrates by the use of ink jet printers. On the left is a paper-based SERS substrate, produced using silver colloid printed onto standard Whatman™ filter paper. The printed substrate shown is 1×1 cm² on a 4.5 cm diameter filter paper, but can be easily varied in size and shape. A standard piece of Whatman™ filter paper without SERS substrate which can be used as a non-SERS swipe (4.5 cm diameter) is shown on the right.

### Example 1

### Detection of Nuclear and Industrial Contaminants

The following example demonstrates that trace quantities of contaminants can be detected by using a simple dry swipe of the contaminant from a surface in a typical operational environment. In practice, these contaminants may be in the form of dust on furniture, floors, walls or ceilings. They may be absorbed on surfaces such as inside glove boxes, ductwork or in exhaust lines of fumehoods. They could also be components within special coatings such as plastics or paints. The contaminants can be nuclear contaminants and/or industrial contaminants. The media that have been chosen to demonstrate the efficacy of dry SERS swiping should be regarded as a convenient method to attain trace quantities of the relevant contaminants in a dried state.

Use of ¹³⁷Cs as a Tracer

Radioactive ¹³⁷Cs can be used as a convenient tracer to assess the swiping efficiency on the swipe relative to the deposited amount on the glass substrate. Trans-1,2-bis(4-pyridyl)ethylene (BPE) was used as the analyte in this study. A known amount of ¹³⁷Cs was added to a solution of BPE and 3 μl was pipetted on a glass surface as well as on a flexible SERS substrate. The total activity of the ¹³⁷Cs on the glass plate was measured using a NaI radiation spectrometer. A swipe of the of the glass plate using a flexible SERS substrate was then made, similar to the swipes to be discussed. The amount of ¹³⁷Cs on the swipe was measured using the NaI spectrometer, as well as the amount of ¹³⁷Cs on the glass substrate after the swipe.

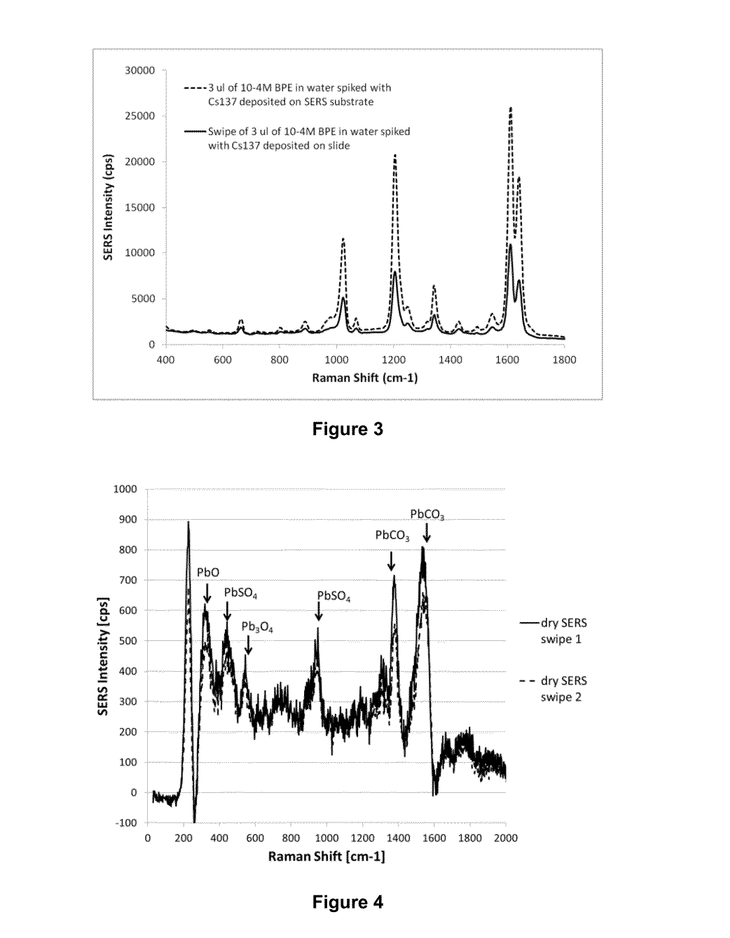

FIG. 2 shows the gamma-ray spectra measured with the NaI spectrometer of the total ¹³⁷Cs activity on the glass plate, on the swipe and the left-over activity on the glass plate after the swipe. The measured relative activity of ¹³⁷Cs gave a swiping efficiency of approximately 50%, in good agreement with conventional swiping efficiencies known in the nuclear industry. FIG. 3 shows the SERS spectrum from the swipe as well as the SERS spectrum from the flexible substrates containing the deposited solution. The reduction in the SERS signal observed in FIG. 3 provides some indication of the loss in SERS signal arising from the use of a dry swipe of a dry sample as opposed to the use of liquid deposition of the same amount of analyte (as in the dry sample) directly on a SERS substrate, followed by the drying of the sample.

Detection of Lead

Lead is commonly used in the nuclear industry because it is very effective in the shielding of radiation. Lead comes in several forms for ease of deployment, such as bricks, sheets, shots and wool. Lead is also found in old paints and is problematic for the decommissioning of nuclear and industrial sites. Lead is one of the identified hazards in the IAEA report (Technical Report Series no. 441) on decommissioning of nuclear facilities. FIG. 4 shows the SERS spectrum from two separate swipes from the side of a lead brick using a flexible SERS substrate. Most of the peaks are known from earlier studies by Raman spectroscopy of various lead compounds (Brooker, M. H. et al., Can. J. Chem. 61 (1983) 494-502) and of products from atmospheric corrosion of lead (Black, L. et al., Applied Spectroscopy 49 (1995) 1299-1304). It is interesting that the SERS spectrum does not contain all the lines observed in conventional Raman spectroscopy, while some of the other lines from the various lead compounds appear to be enhanced. Nevertheless, the use dry swipes to detect trace quantities of lead is well demonstrated.

The use of flexible SERS substrates to measure contaminants requires independent SERS measurements of various compounds that are representative of those found in nuclear and mining operations. Such signatures form the database with which measurements in the field are compared, in order to identify the contaminant. These signatures will bear some similarity to the lines that may already be known from Raman spectroscopy. The matching of signatures from an unknown sample to a database is a well-established technique in the field of gamma-ray spectroscopy, where the database contains the strong gamma-ray lines from various isotopes.

Detection of Uranium

Uranium is at the heart of the nuclear industry. Mining of uranium occurs in many regions of the world, including northern Canada. The processing of uranium leads to enriched uranium (²³⁵U) that is used in atomic bombs and nuclear reactors. The bi-product, depleted uranium, is used for ship ballast and armour-piercing munitions. Natural uranium is used as fuel in the CANDU reactor. Natural uranium is also used for coating of machine parts and in paints and ceramics.

FIG. 5 shows a SERS spectrum from three separate dry swipes on the surface of a natural uranium pellet used by the Canada Deuterium Uranium (CANDU) reactor. A strong peak at approximately 830 cm⁻¹ is observed. This peak is known from previous studies in connection with the detection of uranium contamination in groundwater (Ruan C., et al., Analytica Chem Acta 605 (2007) pp. 80-86) measured using colloidal gold solution mixed with the contaminated ground water to achieve the SERS effect and then analyzed by Raman spectroscopy directly in the liquid phase. The peak is attributed to the stretching vibration of the UO₂²⁺ molecule, which is the main form of uranium under environmental conditions.

Detection of Cadmium

Cadmium is used extensively in the nuclear industry because it has a high affinity for thermal neutrons. Sheets of cadmium are often used to wrap radiation detectors or shield sensitive components from thermal neutrons in the vicinity of nuclear reactors. It is also used in control rods inside reactors to control their power levels. Cadmium is identified as a problematic waste in the IAEA report on decommissioning (IAEA Technical Report Series no. 441).

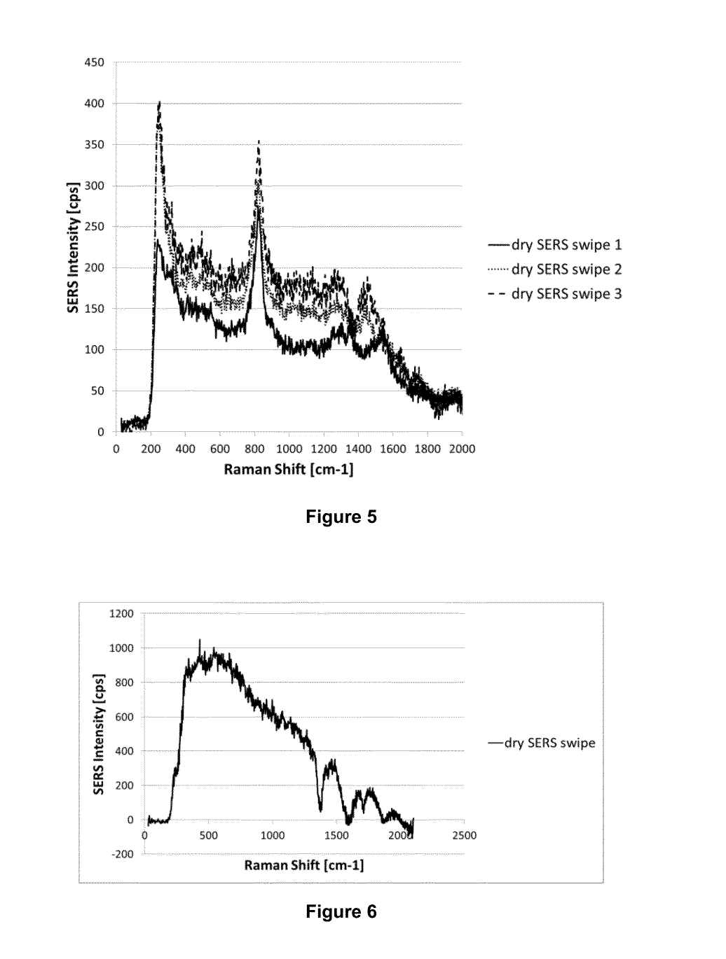

FIG. 6 is the SERS spectrum from swiping a sheet of cadmium with a flexible dry SERS substrate and analysing the substrate with a Raman spectrometer. Cadmium can be detected using a dry flexible SERS substrate.

Detection of Arsenic

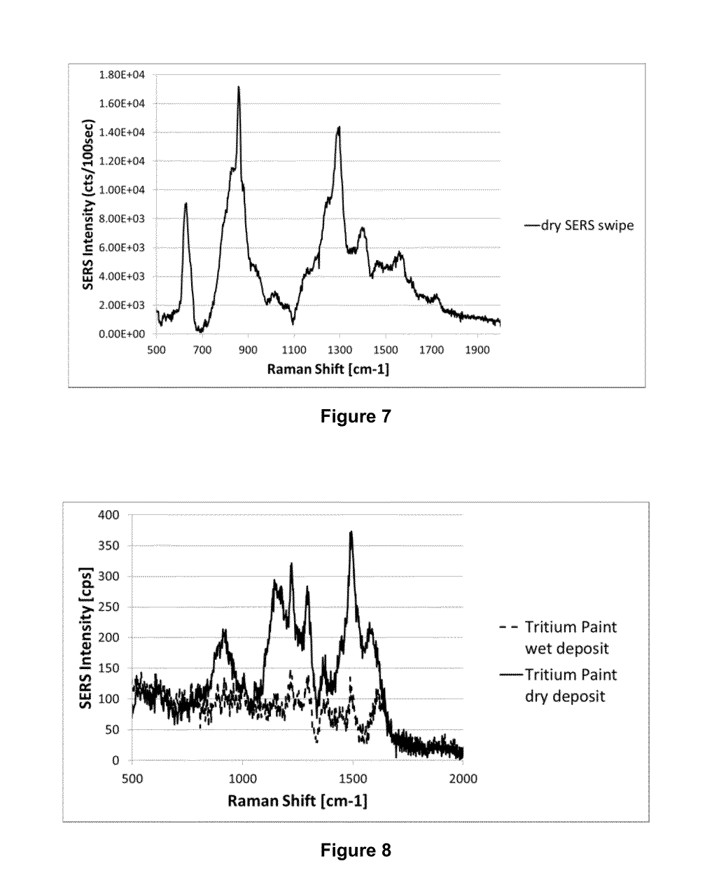

Arsenic is a common contaminant in nuclear and non-nuclear operations. Arsenic is also a common impurity in ores, occurring often as FeAsS, and is released into the atmosphere as fine dust during mining or processing the ore for uranium or other precious metals. Mine tailings often contain hazardous concentrations of arsenic. In locations where arsenic is abundant, the contamination of ground water can be a serious problem. FIG. 7 shows the SERS spectrum from a dry swipe of a dried deposit of arsenic in the form of sodium arsenate. The deposit was prepared by pipetting 3 μl of a 1M solution of sodium arsenate in water on a glass slide and allowing it to air dry. The strong peaks between 700 and 900 cm⁻¹ have been previously identified (Mulvihill, M. et al., Angew. Chem. Int., 47 (2008) 6456-6460) in SERS measurements of arsenic-contaminated ground water using a very elaborated chemical process to produce a suitable substrate. A suspension of silver nanoparticles was produced using the polyol process which led to closely-packed silver nanocrystals followed by surface passivation of the silver nanocrystals with absorbed poly (vinyl pyrrolidone) (PVP) polymer. This suspension was then filtered to achieve a more uniform collection of nanoparticles which are then transferred to a rigid silicon wafer substrate. The PVP was exchanged by benzenethiol (BT) by incubation in a solution of alkanethiols to attain a suitable nanoparticle layer for SERS to occur. The measurement of arsenic was done by liquid deposition of arsenate solution (in water) on the prepared substrate.

FIG. 7 demonstrates that a simple dry swipe of a dried arsenate solution with a flexible substrate can reproduce the same SERS phenomenon as seen by the elaborate chemical process.

Detection of Tritium in Tritiated Paint

In the nuclear industry, tritium can exist in a variety of hazardous forms, ranging from gaseous (HT, DT, and T₂), liquid (HTO, DTO, and T₂O) and in different compounds. The conventional sampling method for tritium varies depending on the form of the hazard. For instance, air sampling is used for gaseous tritium; liquid scintillation counting is commonly used for liquid samples; and the detection of bremsstrahlung from the low-energy beta particles using very sensitive x-ray detectors can be used for surfaces contaminated with tritium or solid forms of tritium contamination. The sample used in this study is in the form of tritiated paint, previously used in luminous (glow in the dark) time-pieces and in the sights of military rifles.

FIG. 8 shows the SERS spectra after depositing 3 μl of the tritiated paint in a toluene solvent on a flexible SERS substrate, immediately after the liquid deposition (wet) and after the paint has dried. The SERS spectrum was much stronger after the paint has dried. The spectral features over the region 1000 cm⁻¹ to 1600⁻¹ are due to the tritiated paint.

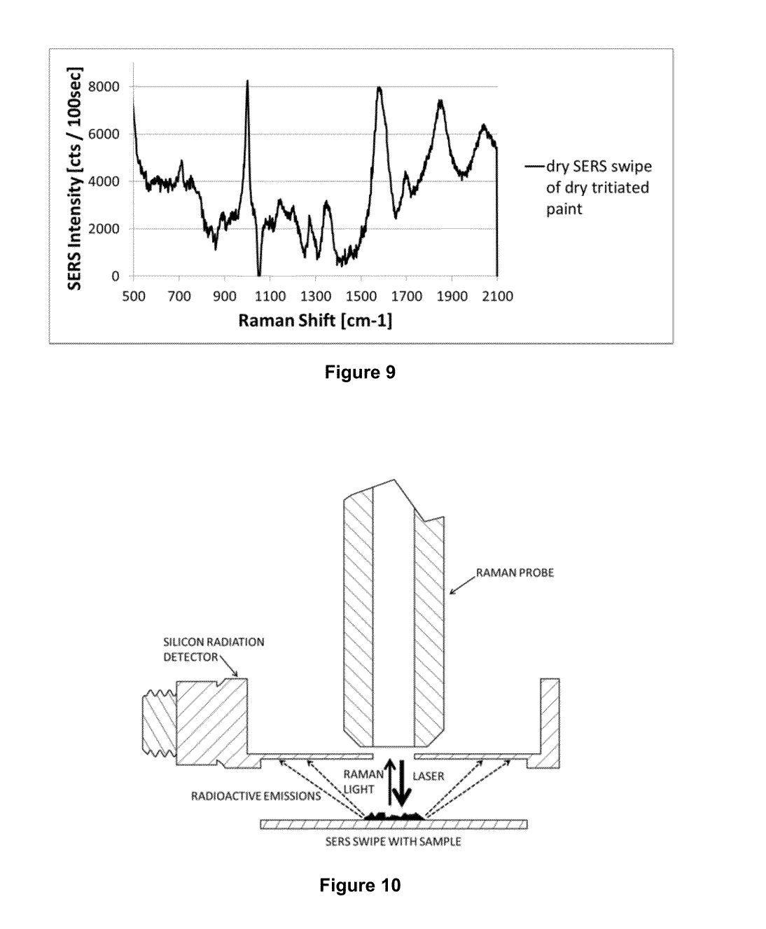

FIG. 9 shows the SERS spectrum from a dry swipe of a 6 μl deposit of a tritiated paint in toluene on a glass substrate after it has dried. Several of the spectral features in FIG. 9 appear in FIG. 8, although their intensities are different, suggesting that swiping may alter the degree of intimate contact of certain molecular components relative to a wet deposition. Nevertheless, the results confirm the applicability of using a flexible SERS swipe to detect and identify tritiated paint.

The features in FIGS. 8 and 9 are not the same as the spectral lines for the (gaseous) hydrogen isotopologues reported by Best et al. (J. Am. Chem. Soc., 1985, 107 (9), pp. 2626-2628), as would be expected. It is not clear which molecular vibrational modes in the tritiated paint are responsible for the features in FIGS. 8 and 9. Nevertheless, these features can be utilized to identify tritiated paint in an environment where such chemicals are handled or have been used. For many industrial or D&D operations, it is sufficient to have the signature of the contaminant of interest, without knowing the molecular basis behind the signature.

### Example 2

### Device for Detecting Industrial and Nuclear Contaminants

For radioactive contamination, the use of radiation detectors is conventional. For certain radionuclides having short half-lives, it may be that radiation detection provides much greater sensitivity than the use of SERS. However, it has been mentioned that radiation detection is sometimes inadequate. This is the case when detecting long half-life radiation emitters such as uranium and thorium or low energy beta emitter such as tritium ⁶³Ni or ¹⁵¹Sm. However, contaminants in the nuclear industry include also non-radioactive hazardous materials, for which radiation detectors cannot be used. Thus, SERS and radiation detection can be regarded as complementary technologies.

A portable instrument that utilizes both technologies that has the capability of detecting radioactive as well as non-radioactive hazards, both of which are of great concern in operational and D&D activities, is an addition to existing instrumentation that are known to be inadequate to meet regulatory requirements. Radiation detection is a mature technology and many detector types can be combined with Raman for such an application. One radiation detector that can be used is a large area Si solid state radiation detector. Such detectors are available in an annular form, having a hole in the center. A central hole in the detector allows for the use of an interrogating laser beam to pass through to interrogate the sample for SERS analysis. The annular Si-detector detects any radiation that may be emanating from the sample and the Raman detector identifies the same or other species more easily detectable using Raman SERS technology. A schematic drawing of an exemplary device is shown in FIG. 10. Such a portable instrument can be used for field operations for detection of radioactive and non-radioactive contaminants.

### Example 3

### Swiping Techniques

Swiping of contaminated surfaces is done routinely in commercial and industrial environments. In the nuclear industry, standard protocols for performing such swiping are commonly followed. For alpha and low-energy beta contamination as well as for non-radioactive contaminants, after swiping, prior techniques involve taking the swipes off site and to a specialized laboratory for identification of any contaminants on the swipe. Specially-developed swipes or special wetting-agents on the swipes can be used for particular operations.

Despite the routine use of many different swipes in the nuclear industry, the choice of the swipe for a particular application is still often done by crude experimentation using different types of swipes. The method used for the analysis of the swipe influences this choice since the ultimate detection capability is dependent on both the swipe and the readout. In the case of analysis by liquid scintillation (common for alpha and low-energy beta analysis), the scintillation cocktail to be used also impacts this choice. The swipe used for liquid scintillation analysis may not necessarily be the best for analysis by gross alpha/beta counting.

Commercial swipes are available in many substrates including mixed cellulose esters, water-soluble paper, polyethersulfone membrane, glass fiber, polytetrafluorothylene membrane, nylon membrane, PVDF hydrophobic membrane, polypropylene membrane and many others. Often these swipes come in different grades and are sometimes coated with particular surface treatments. Thus, the selection of the best swipe or filter for a particular application is not a simple task.

In addition to the selection of a particular swipe, the choice of whether or not to wet the swipe is another decision that is determined by the particular application. In general, it has been found that pre-wetting a swipe with water, a 50/50 alcohol/water mixture or other solvent will improve collection efficiency. Pre-wetting with a dilute acid can also provide good collection efficiency. In practice, the choice of the swipe and method of usage is dictated by the need to meet the regulatory requirements for the particular operation. Once the detection limit is met, the particular choice is considered satisfactory.

Investigations of enhancement of the SERS signal to date for flexible substrates has mainly been done by deposition of the analyte in a liquid medium on the SERS substrate using a pipette or contacting the analyte in solution form with the SERS substrate either directly or by paper chromatography (Yu, W. et al., 22 Mar. 2012, SPIE Newsroom. D01:10.1117/2.1201203.004139). However, these methods are not convenient for field applications, where a dry swipe is most desirable, but the practice of pre-wetting a swipe is also an established approach.

The use of Au and Ag nanoparticles produced by laser ablation to yield nanoparticles of various sizes was studied by Herrera, G. M. et al. (Nanomaterials 2013 (2013) 158-172). They obtained high surface enhancement factors for TNT based on Au colloids deposited on glass slides irradiated with laser light at 785 nm. This same group produced a flexible filter substrate containing Au nanoparticles using the thermal inkjet printer technology and obtained good detection efficiency for TNT and some of it degradation products (Fierro-Mercado, P. M. et al., Int. Jour. Of Spectroscopy, 2012 pp. 1-8). These measurements were done by depositing the dissolved analyte in ethanol on the SERS substrate using a pipette. The preparation of gold nanoparticles having its surface modified by cysteine is reported by Dasary, Samuel S. R. et al. (J. Am. Chem. Soc. (2009) pp. 13806-13812). The authors claim that in the presence of TNT, cysteine-conjugated gold nanoparticles forms Meisenheimer complex due to electrostatic interactions to provide significant enhancement of the SERS signal. These measurements were done by depositing solutions of TNT and SERS colloids onto a glass slide and analyzing it with a Raman spectrometer.

SERS substrates can be developed which are suited for a particular field applications having an appropriate substrate as well as the type of nanoparticle colloid to attain the desired detection sensitivity. In the much quoted publication by Lee, P. C. et al. (J. Phys. Chem. 86 (1982) 3391-3395) where the “classical recipe” for the production of Ag nanoparticles was first published and subsequently followed by numerous researchers, the recipe for the production of Au nanoparticles for SERS applications was also described. By adapting this recipe and adapting the dilution step for altering the viscosity of the colloid to be suitable for ink-jet printing, SERS substrates can be produced based on Au nanoparticles. Such substrates may have certain advantages for detection of industrial contaminants relative to the Ag nanoparticle SERS substrate which has been studied so far.

None of the prior studies involving the use of flexible SERS substrates to determine surface enhancement factors or limits of detection sensitivity for particular analytes have used the SERS substrate as a dry swipe to pick up the analyte. All these studies utilize the liquid phase to enable the analyte to come into intimate contact with the nanoparticles for SERS to occur. The presently described work demonstrates that dry swiping is efficient and useful for field application. Results have confirmed that the surface enhancement factor for a dry swipe is not significantly lower than that from liquid deposition (the classical sample preparation technique) and this method of sample preparation is quite satisfactory for the envisaged applications.

To achieve improved surface enhancement factor for a dry swipe, if necessary, it has also been shown that pre-wetting of the SERS substrate with a wetting agent may be used, in keeping with established practice in the nuclear industry. Suitable wetting agents can include but are not limited to water, alcohol, mild acid, and any other suitable solvent. Reagents such as cysteine may also open the door to a new class of wetting agents for SERS swipes capable of modifying the molecular structure of the analyte to enable more intimate bonding to the plasmonic nanoparticles to achieve significant improvements to SERS signals.

Dry Swiping onto a SERS Substrate

The present method and system can be used for detecting chemical species on dry surfaces. Specifically, chemical species can be effectively swiped with dry flexible SERS substrates and subsequently interrogated by a Raman Spectrometer. Contaminants can thus be detected on site in various locations.

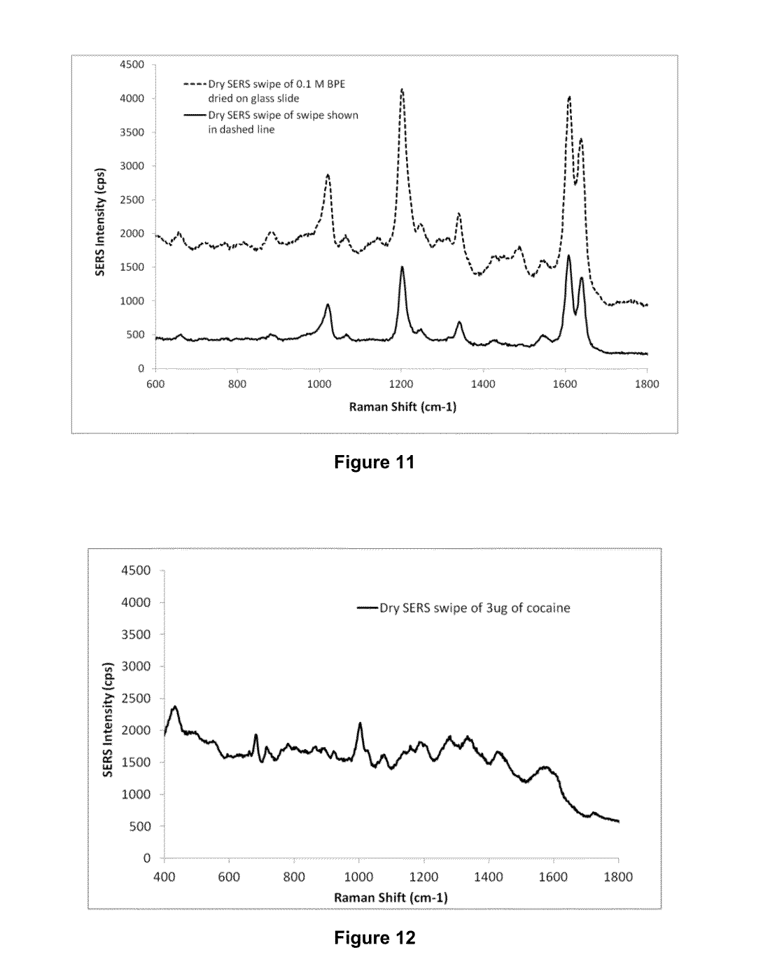

There may be certain circumstances where SERS substrates cannot be used directly to swipe a surface. In this case, a conventional swipe can be used. In such circumstances, it is possible to use a flexible SERS substrate to swipe contamination that has been picked-up by a swipe. FIG. 11 demonstrates the feasibility of this process. In this example, a first SERS swipe is used to swipe a surface. In this case, a swipe of a dried deposit of BPE is made using a SERS substrate (top curve). In a second trial, a flexible SERS substrate is used to swipe the first swipe (lower curve). The intensity of the case wherein the second flexible SERS substrate is used to swipe a first swipe is lower than the first, as expected. The use of SERS substrate rather than a non-SERS substrate for the first swipe in this example was to allow quantitative assessment of the swiping efficiency of the second swipe. This demonstrates that a first non-SERS swipe can be used to pick up a contaminant from a surface and then employed to transfer the contaminant to a second SERS substrate for SERS Raman interrogation while still maintaining sufficient detection of the contaminant. No contact of the SERS swipe with a solvent is required after swiping to obtain adequate SERS spectral analysis. Accordingly, FIG. 11 confirms that a SERS substrate can be used to swipe contamination picked-up by a first swipe.

Flexible SERS substrates can be used for detection and determination of organic contaminants that are difficult or impossible to detect with existing hand-held instrumentation. The dry flexible SERS substrate can be used to swipe a dry surface to pick up any contaminants to be tested. After swiping a surface, the swipes can be analyzed with a portable Raman spectrometer. The quantification of the swipe reading (if desired) can also be established in a separate measurement by swiping a similar surface, and spiking the sample with a known amount of the contaminant or a suitable tracer.

To demonstrate the feasibility of using flexible SERS substrate for the desired application, SERS spectra were measured for a few representative compounds by swiping specially prepared contaminated surfaces. FIG. 12 shows the SERS spectrum from a dry swipe of a dried 3 μg cocaine deposit on a glass slide. The SERS spectrum for cocaine is essentially identical and resembles SERS spectra for cocaine obtained by others by liquid deposition (Netti, C. et al., Spectroscopy, Jun. 1, 2006). Accordingly, flexible SERS substrates can be used to dry swipe organic species directly from surfaces for direct interrogation by a Raman spectrometer

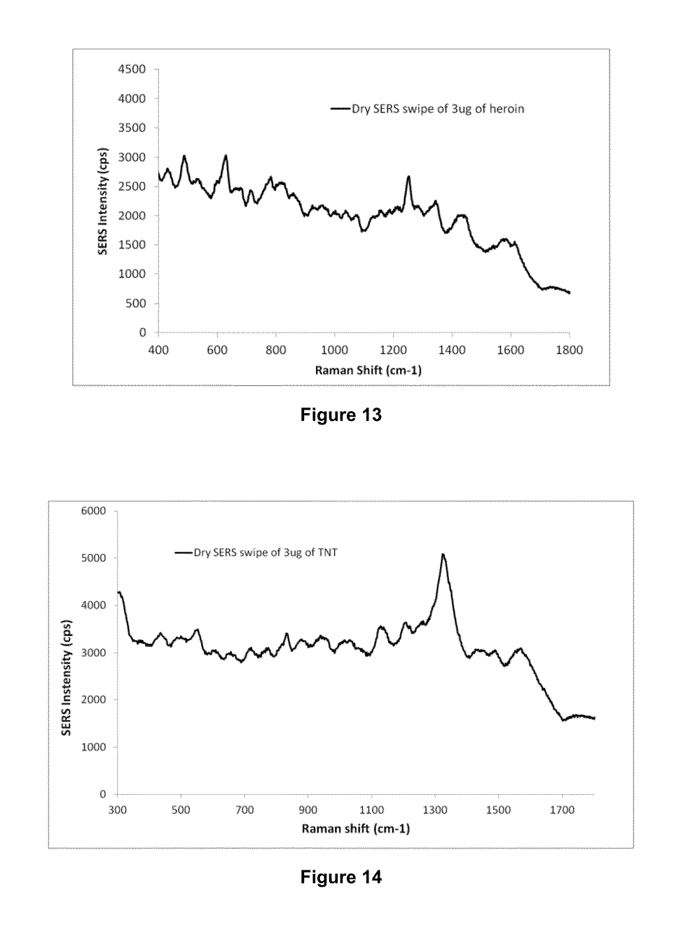

FIG. 13 is a SERS spectrum from a dry swipe of a dried 3 μg deposit of heroin on a glass slide. The features of the heroin spectra are similar to those in the literature (Yu, W. W. et al., Analyst 138 (2013) pp. 1020-1025) obtained by using a solution of the analyte.

FIG. 14 shows the SERS spectrum from a dry swipe of dried 3 μg deposit of the explosive Tri-NitroToluene (TNT) on a glass slide. The prominent peak around 1300 cm⁻¹ is indicative of TNT and the spectra resemble the SERS spectrum of TNT (Fierro-Mercado, P. M. et al., Int. Jour. Of Spectroscopy, 2012 pp. 1-8) taken using a liquid reagent consisting of TNT in ethanol. The SERS measurement was done by pipetting 5 μl of the reagent on a flexible SERS substrate and measuring it with a Raman spectrometer after it has dried. This method of sample preparation is completely different from the use of a dry swipe, shown in FIG. 14, which is desirable for field application.

Wet Swiping onto a SERS Substrate

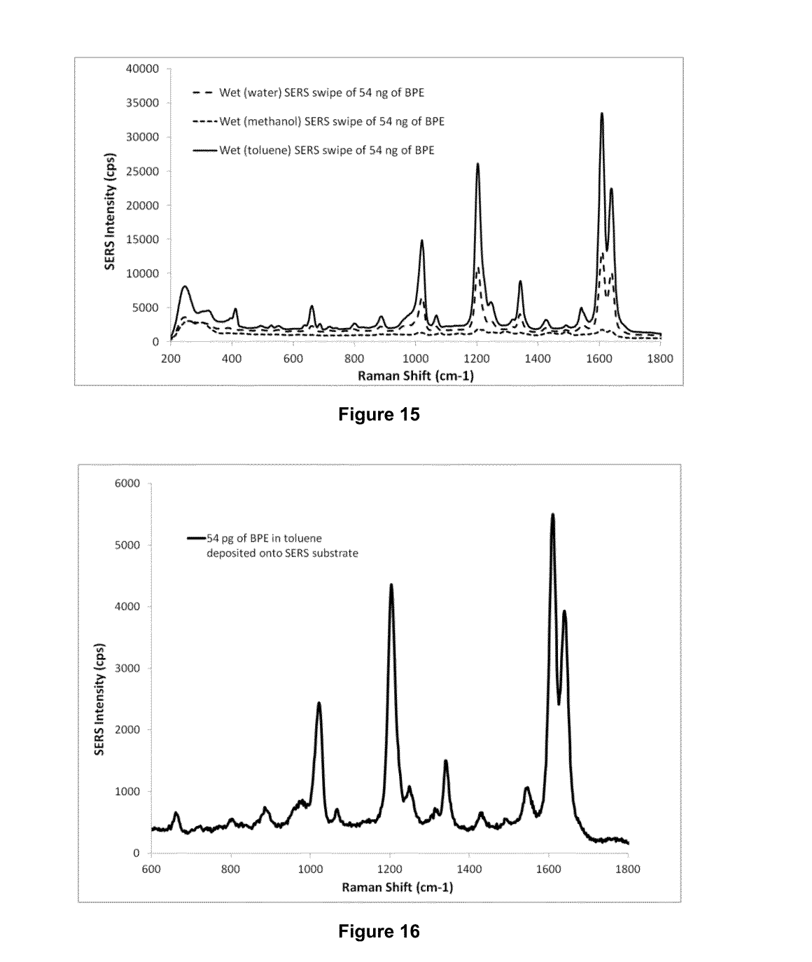

FIG. 15 shows the SERS spectrum from a dried deposit of BPE, swiped with a flexible SERS substrate moistened with toluene (top), water (middle) and methanol (bottom). The moistening was done by depositing 3 μl of the respective liquids on the SERS substrate before the swipe and waiting for 30 minutes for all the samples to air dry. These liquids were selected for demonstrative purpose only. The moistening of the SERS substrate does not affect the spectral features of the BPE SERS spectrum, as can be concluded by comparison with FIG. 16, which shows a SERS spectrum from a sample prepared by depositing 3 μl of 10⁻⁷M BPE on flexible SERS substrate and then dried. The sampling efficiency is clearly impacted by the solvent used for wetting the swipe.

### Example 4

### Detection of Air Contaminants

Air sampling systems of numerous designs are used routinely in the nuclear and other industries where hazardous materials are handled. The main function of the air sampling system is to draw potentially contaminated air through a medium (such as a filter) in order to increase the concentration of the contaminant on the substrate to permit easier detection of the contaminant.

Flexible SERS substrates can be prepared on various conventional as well as specially designed filter papers which can be deployed directly in air samplers that are in routine use in the nuclear industry. These filter papers come in different grades depending on the pore size and filter thickness, giving different flow rates and degree of retention as well as in different media dependent on the type of contaminant to be monitored. One of the oldest and most common filter for air sampling is the fibrous filter, which is composed of a mat of cellulose, glass, quartz, asbestos or plastic fibers in random orientation. Another type is the granular bed, in which solid granules are packed into definable sheet or bed. The granules are often sintered to the point where they form a rigid mechanical structure. Among commercial filters, Whatman #41 cellulose fiber filter and Versapor™ R membrane, made of acrylic copolymer on a nonwoven nylon support, are commonly used for air sampling. Other specialized collection media include cartridges of silica gel, molecular sieves, activated charcoal and silver zeolite. FIG. 1 is a photograph of a SERS substrate applied to a piece of filter paper that can be used for detection of nuclear contaminants in air. By substituting conventional filter paper with SERS filter paper and analyzing the SERS filter with a Raman spectrometer, the contaminant type can be identified, as well as the concentration of the contaminant in the air. This analysis can also be done directly in the field, without the need to send the filter paper for off-site processing.

An in-field Raman measurement can be done by removing the SERS filter paper and using a portable Raman spectrometer, or can be done in situ by modifying the air sampler to accommodate the Raman spectrometer. An in-field detector of industrial contaminants in air can comprise a Raman spectrometer, including a laser beam, and a flexible SERS substrate that can be exposed to air and periodically tested. In one embodiment of an in-field detector of industrial contaminants in air, multiple SERS substrates or a continuous roll of substrate can be incorporated into the device, and a mechanism can be provided to automatically advance the SERS filter paper so that the device can be used as a continuous industrial air sampler. Calibration of the filter paper for various contaminants can be done ahead of time in a controlled air environment spiked with a known amount of the contaminant or a suitable surrogate. A library of SERS spectra for various contaminants can also be stored in a memory of the air sampler so that contaminant identification can be done on site.

To demonstrate the applicability of using flexible SERS substrates for air sampling, gasoline vapour was used as a test agent of interest. Gasoline vapour was pumped through the substrate using a mechanical vacuum pump. To prepare the vapour, 50 ml of gasoline was placed into a 500 ml Erlenmeyer flask. The top of the flask was sealed with a rubber stopper having a small glass tube at the center to allow for air ingress. The side of the flask had a glass tube that is normally used for connection to a vacuum. A tygon™ tube was connected the glass tube of the Erlenmeyer flask to a mechanical pump. Between the glass tube and the pump, a micropore filter plastic holder assembly was installed to provide a convenient surface to mount a 25 mm² SERS substrate. A plastic foil, with a hole to match the SERS substrates area was used to block air from passing through the rest of the micropore filter, so that only the vapour from the gasoline was passed through the SERS substrate.

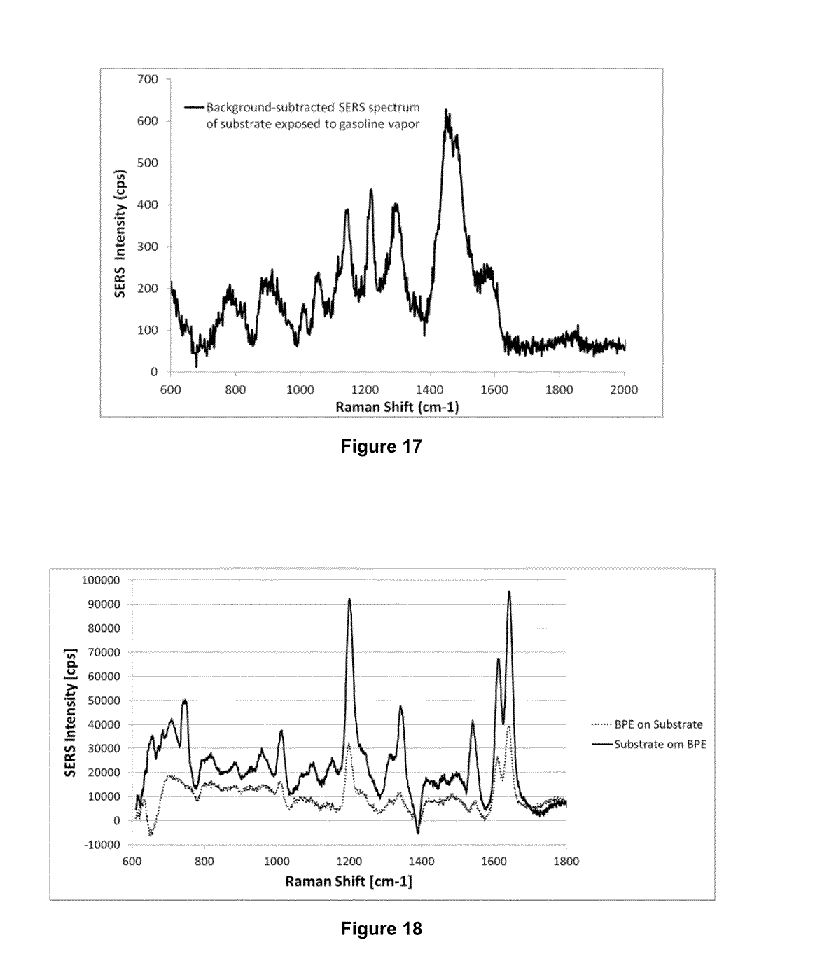

Due to the design of the experiment, the air flow was very low compared to most industrial air samplers. However, the experiment was adequate to demonstrate feasibility of using flexible SERS substrates for air sampling applications. After pumping for a few hours, the SERS substrate was removed and analyzed with the Raman spectrometer. The results of the Raman interrogation of the SERS substrate is shown in FIG. 17. The features in the spectrum are similar to those previously measured for gasoline by Raman spectroscopy (Xu, Q. et al., Sensors and Actuators B, 146 (2010) pp. 75-78)

This experiment demonstrates the technical feasibility of using a flexible SERS substrate as a filter in an air sampling system. It is understood that the detection of gasoline in the air by capturing the gasoline on a SERS substrate exposed to air flow demonstrates that other chemical species, such as nuclear and non-nuclear contaminants, can also be detected in the air in a similar manner. The peaks, especially the most intense at 1479 cm⁻¹ shown in FIG. 17, correspond to those previously observed by Raman spectroscopy.

### Example 5

### In situ SERS Substrate

Some surfaces, such as those that are rough, may not be suitable for the use of swipes. A SERS nanoparticle colloid can be prepared in the form of ink or substance that can be directly applied to a surface to create a SERS substrate in situ. In this way, ink mixtures such as those used in printer cartridges for the preparation of SERS substrates onto porous surfaces can be directly applied to a surface to form a thin layer of plasmonic nanoparticles suitable for Raman spectroscopy. In one method, a SERS nanoparticle colloid is sprayed onto the surface using a pressurized container similar to those for hair spray, to form a layer a few microns thick. The SERS nanoparticle colloid can also contain a desired tracer for quantification of the level of contamination being assessed. A portable Raman spectrometer can then be used to interrogate the surface coated with SERS nanoparticle colloid to record the Raman spectrum for chemical species on the treated surface. This technique may also find application in the monitoring for fixed contamination (e.g. after a surface is swiped for removal contamination).

FIG. 18 shows SERS spectra from BPE for two methods of sample preparation. In one case, the silver (Ag) colloid was deposited on a substrate and dried. Then an aliquot of BPE in solution was deposited on the SERS substrate and allowed to dry. The sample was then interrogated by Raman spectroscopy (top). In the second case, an aliquot of BPE is deposited on a substrate and allowed to dry. An Ag colloid was then deposited on top of the dried BPE and the sample was again allowed to dry. The sample was then interrogated by Raman spectroscopy (bottom). The observation of the same SERS spectrum in this sample prepared by an “inverse” process of preparing the SERS substrate confirms that depositing a SERS colloid solution directly onto a surface of interest that may be difficult to swipe, can be used for trace detection of contaminants by SERS.

All publications, patents and patent applications mentioned in this Specification are indicative of the level of skill of those skilled in the art to which this invention pertains and are herein incorporated by reference to the same extent as if each individual publication, patent, or patent application was specifically and individually indicated to be incorporated by reference.

Although the present invention has been described with reference to the preferred embodiments, it is to be understood that modifications and variations may be resorted to without departing from the spirit and scope of the invention, as those skilled in the art readily understand. Such modifications and variations are considered to be within the purview and scope of the invention and the appended claims.

1. A method of detecting one or more contaminants on a surface comprising:
swiping the surface with a flexible SERS substrate; and
directly interrogating the flexible SERS substrate with a Raman Spectrometer to obtain a SERS emission spectrum of the contaminants.

2. The method of claim 1, wherein the flexible SERS substrate is dry.

3. The method of claim 1, wherein the flexible SERS substrate is moistened to aid in transferring the contaminants from the surface to the flexible SERS substrate

4. The method of claim 1, wherein the surface is a non-SERS swipe.

5. The method of claim 1, further comprising identifying the contaminants by comparing the SERS emission spectrum of the contaminant to a library of SERS emission spectra.

6. The method of claim 1, further comprising quantifying the contaminants on the surface.

7. The method of claim 1, wherein the contaminant is an industrial contaminant, a nuclear contaminant, or a mixture thereof.

8. A system for detecting one or more contaminants on a surface, the system comprising:
a Raman Spectrometer for receiving a flexible SERS substrate having the one or more contaminants thereon; and
a memory comprising a library of spectra for a plurality of contaminants.

9. The system of claim 8, further comprising a radiation detector to detect radiation from nuclear contaminants.

10. The system of claim 9, wherein the radiation detector is capable of detecting alpha particles, beta particles, or both.

11. A method for detecting a contaminant on a surface, the method comprising:
applying a mixture containing plasmonic nanoparticles to the surface;
interrogating the surface with a Raman Spectrometer to obtain a SERS emission spectrum for the contaminant; and
identifying the contaminant by comparing the SERS emission spectrum to a library of SERS emission spectra.

12. The method of claim 11, wherein the mixture comprises a colloid containing plasmonic nanoparticles dispersed in a carrier solvent at a suitable viscosity, spiked by reagents that:
assist in the bonding of the nanoparticles to the selected industrial contaminant; and/or
chemically react with the contaminant so as to achieve a high surface enhancement factor for Raman Spectroscopy.

13. The method of claim 11, wherein the step of applying the mixture comprises spraying, squirting, dripping, dipping, painting or a combination thereof.

14. The method of claim 11, wherein the surface is in a nuclear facility or an industrial facility.

15. A system for detecting one or more contaminants in air, the system comprising:
one or a plurality of flexible SERS substrates;
means for mounting the flexible SERS substrates to allow exposure to air;
a Raman spectrometer for interrogating the flexible SERS substrates to obtain a SERS emission spectrum for the contaminants; and
a library of SERS emission spectra to enable the ability to identify the contaminants by comparing the spectral emission of the contaminants to the library of SERS emission spectra.

16. The system of claim 15, wherein the plurality of flexible SERS substrates are in a cartridge or in a continuous strip.

17. The system of claim 15, wherein the exposure to air is accomplished by the use of mechanical means to pump the air through the flexible substrates.

18. A method for detecting one or more contaminants in the air, the method comprising:
sampling air by exposing a SERS substrate to air;
interrogating the SERS substrate with a Raman spectrometer to obtain a SERS emission spectrum for the contaminants; and
identifying the contaminants by comparing the SERS emission spectrum for the contaminants to a library of SERS emission spectra.

19. The system of claim 8, wherein said contaminants comprise industrial contaminants, nuclear contaminants, or a mixture thereof.
